(19) United States
(12) Patent Application Publication
(10) Pub. No.: US 2004/0032392 A1
(43) Pub. Date: Feb. 19, 2004

(54) Mouse pen device having remote-control function

(75) Inventors: Chung Ping Chi, Chung Ho City (TW); Kun Chan Wu, Chung Ho City (TW); Chao-Wu Chien, Chung Ho City (TW); Sheng An Tsai, Wan Shun Tsun (TW)

Correspondence Address: BROWDY AND NEIMARK, P.L.L.C., 624 NINTH STREET, NW, SUITE 300, WASHINGTON, DC, 20001-5303, US

(73) Assignee: Topseed Technology Corp., Chung Ho City (TW)

(21) Appl. No.: 10/222,802

(22) Filed: Aug. 19, 2002

(51) Int. Cl. G09G 5/00

(52) U.S. Cl. 345/156

(57) ABSTRACT

A mouse pen device having remote-control function comprises an optical detection unit, a control unit, an operation unit, and a wireless emission unit. The optical detection unit is used to emit light and receive the reflected light signal so as to detect the motion of the mouse. Whether the control unit operates in the mouse mode or the remote-controller mode is based on the intensity of the reflected light signal. The operation unit provides corresponding key definitions of mouse and remote controller. The wireless emission unit is used to emit the signal processed by the control unit. Thereby, an operational mode of mouse is achieved when the mouse pen is pressed close to the desk in use, while an operational mode of remote controller is achieved when the mouse pen stands off the desk in use.

### FIELD OF THE INVENTION

The present invention relates to a mouse pen device having remote-control function and, more particularly, to a mouse pen having both functions of a mouse and a remote controller.

### BACKGROUND OF THE INVENTION

Along with the popularity of operating systems using windows and the trend of graphic software interfaces, mice have become important input devices of computer peripherals. According to the detection way of position, mice can be roughly divided into mechanical type and optical type. The outer appearances of mice have also evolved from rectangular shapes to streamline shapes conforming to ergonomics to facilitate manipulation of users. The emergence of pen-shaped mice lets users obtain smoothness like holding a pen for writing when they manipulate the pen-shaped mice. Matched with the slender characteristic thereof, pen-shaped mice can be more conveniently taken along with notebook computers.

Moreover, because of the portable characteristic of notebook computers, many people utilize the notebook computers matched with projectors for briefing when they go out visiting customers. During the briefing, the user usually uses a remote controller to manipulate the playing flow of briefing. However, if a computer leaves the playing of briefing back to the operational mode of computer, it must return to the operational mode of mouse to continue subsequent manipulations of computer.

Accordingly, because the user must operate the remote controller and the mouse to and fro during the briefing, the above remote controller for playing of briefing and the above mouse for manipulating a computer have inconvenience and drawbacks in practical use and portability. The present invention aims to propose a mouse pen device having remote-control function to resolve the problems in the prior art.

### SUMMARY OF THE INVENTION

The primary object of the present invention is to provide a mouse pen device having remote-control function, which, in addition to the manipulation function of a mouse, has also the manipulation function of a remote controller. Moreover, the mouse function or the remote controller function of the mouse pen can be automatically determined according to the operational way of user.

Another object of the present invention is to provide a mouse pen device having remote-control function, wherein operational keys are defined for the mouse function and the remote controller function to reduce the number of keys and lower the production cost.

To achieve the above objects, the present invention provides a mouse pen device having remote-control function, which comprises an optical detection unit, a control unit, an operation unit, and a wireless emission unit. The optical detection unit is used to emit light and receive the reflected light signal. The control unit is electrically connected to the optical detection unit. The control unit is used to compare the reflected light signal received by the optical detection unit with a preset value. Whether the control unit operates in the mouse mode or the remote controller mode is based on the comparison result. The operation unit is electrically connected to the control unit. The wireless emission unit is electrically connected to the control unit, and is used to emit the signal processed by the control unit.

The various objects and advantages of the present invention will be more readily understood from the following detailed description when read in conjunction with the appended drawings, in which:

### BRIEF DESCRIPTION OF THE DRAWINGS

FIG. 1 is a perspective view of the present invention;

FIG. 2 is a circuit block diagram of the present invention; and

FIG. 3 is a circuit diagram of the present invention.

### DETAILED DESCRIPTION OF THE PREFERRED EMBODIMENTS

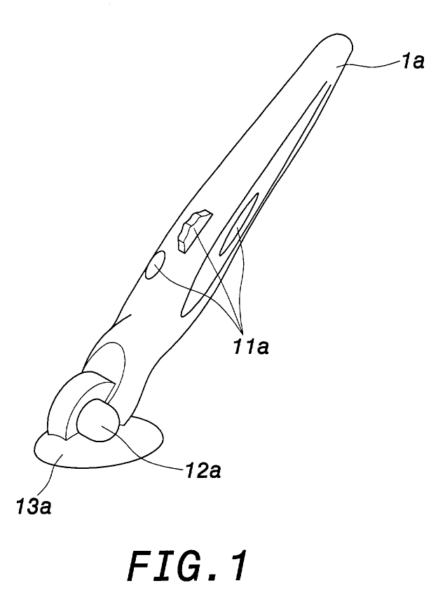

As shown in FIG. 1, a mouse pen device having remote-control function is made as the shape of a mouse pen 1a. Several manipulation keys 11a are, disposed at the outside of the mouse pen 1a. The front end of the mouse pen 1a is connected to a detection head 13a for detecting the motion of the mouse pen 1a through a rotation mechanism 12a to have manipulative convenience of both a remote controller and a mouse. Optical detection and wireless transmission techniques are exploited to accomplish the functions of an optical mouse and a wireless remote controller. The rotation mechanism is used to let a user manipulate the angle between the mouse pen 1a and the detection head 13a with different angles so as to have a more flexible manipulative angle when the mouse pen 1a operates in the mouse mode (the detection head 13a is pressed close to the desk).

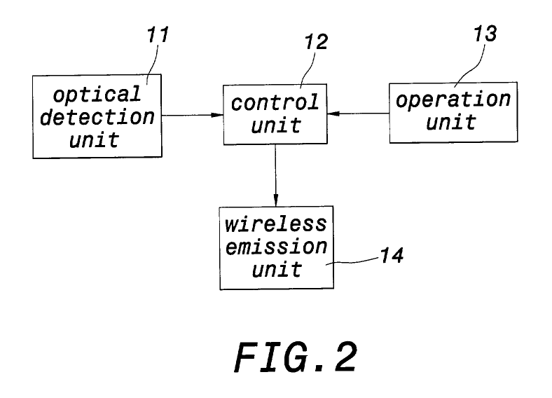

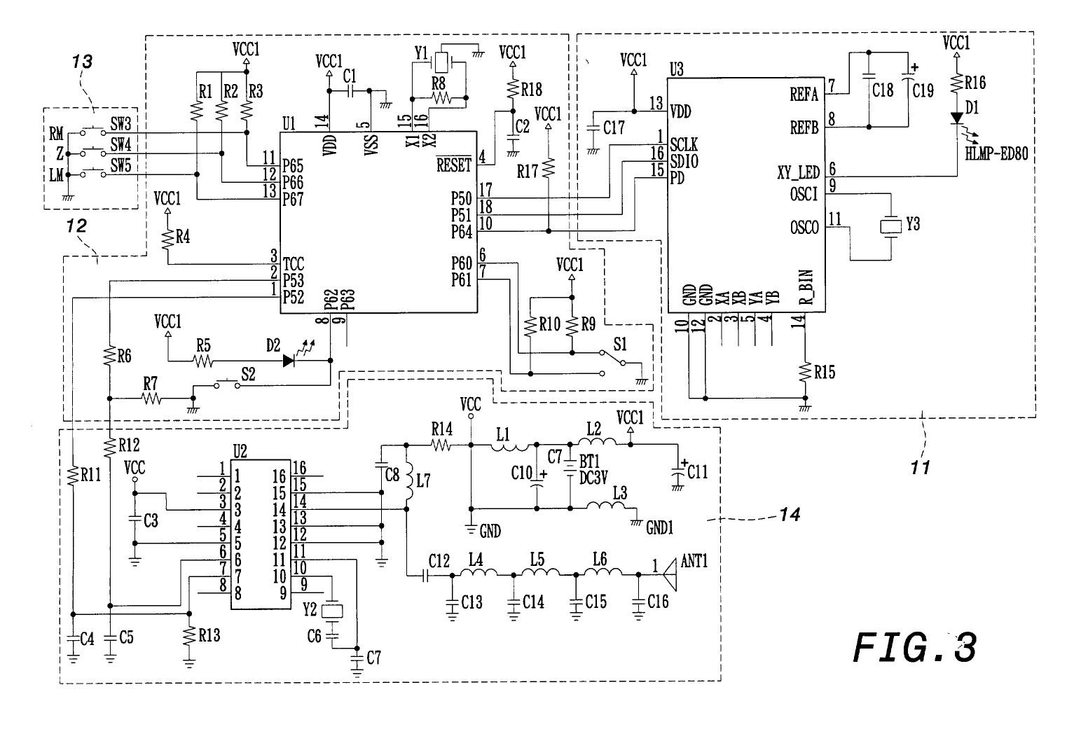

As shown in FIGS. 2 and 3, a mouse pen 1 mainly comprises an optical detection unit 11, a control unit 12, an operation unit 13, and a wireless emission unit 14.

The optical detection unit 11 utilizes the same optical technique of a general optical mouse for detecting the motion of mouse. The optical detection unit 11 comprises a conversion chip U3, a light emitting device D1, and other components. The conversion chip U3 converts the analog signal of the reflected light into a digital signal representing the motion parameters of mouse according to the light emitted by the light emitting device D1 and the received reflected light.

The control unit 12 is electrically connected to the optical detection unit 11, and has the function of processing a mouse and a remote controller. The control unit mainly comprises a microprocessor U1 and other components. Because the control unit 12 has both the control functions of a mouse and a remote controller, how to determine whether the control unit operates in the mouse mode or the remote controller mode is very important. Because a mouse is normally pressed close to the desk for use and a remote controller stands off the desk and is held in hands for use, and the mouse used in the present invention is an optical mouse, whether the control unit 12 operates in the mouse mode or the remote controller mode can be determined according to the intensity of the reflected light signal of the optical detection unit 11. In other words, a higher intensity of the reflected light signal of the optical detection unit represents that the mouse pen 1a is pressed close to the disk and operates in the mouse mode. Contrarily, a lower intensity of the reflected light signal of the optical detection unit represents that the mouse pen 1a stands off the disk and operates in the remote controller mode.

The program in the control unit 12 compares the reflected light signal of the optical detection unit 11 with a preset value. When the light signal is larger than the preset value, the control unit 12 operates in the mouse mode. Contrarily, when the light signal is smaller than the preset value, the control unit 12 operates in the remote controller mode. However, the control unit 12 can also be switched to operate in the mouse mode or the remote controller mode by manually switching switches S1 and S2. Matched with the display state of the light emitting device D1, whether the mouse pen 1a operates in the mouse mode or the remote controller mode can be clearly known.

The operation unit 13 is electrically connected to the control unit 12, and comprises several keys SW3, SW4, and SW5 (i.e., the manipulation keys outside the mouse pen). In order to reduce the number of keys, the keys SW3, SW4, and SW5 gave both the key functions of a mouse and a remote controller. That is, when the control unit 12 operates in the mouse mode, the keys SW3, SW4, and SW5 are defined as a mouse left key, a mouse wheel key, and a mouse right key, respectively. Contrarily, when the control unit 12 operates in the remote controller mode, the keys SW3, SW4, and SW5 are defined as a Page UP key, a Scroll key, and a Page Down key, respectively.

The wireless emission unit 14 is electrically connected to the control unit 12, and mainly comprises an emission chip U2 and other components. The wireless emission unit 14 is used to emit the signal processed by the control unit 12 to a receiver (not shown) connected to a computer so that the computer can respond to the received signal. In other words, when the control unit 12 processes the signal of mouse, the computer responds action messages of mouse. When the control unit 12 processes the signal of remote controller, the computer responds manipulation messages of remote controller.

When a user makes a briefing, he can uses the mouse pen 1a of the present invention to operate in the mouse mode or the remote controller mode. When the mouse function is to be used, he presses the mouse pen 1a close to the desk for use. When the remote-control function for playing of briefing is to be used, he takes the mouse pen 1a a certain distance from the desk for use. Or the user can also directly designate the mouse pen 1a to operate in the mouse mode or the remote controller mode by manual switching. Therefore, the manipulation has more flexible selection to meet the requirements in different situations.

To sum up, the mouse pen device having remote-control function of the present invention has the following characteristics.

(1). The mouse function and the remote controller function are integrated to let the playing process of briefing be smoother and the operation be more convenient when a user makes a briefing.

(2). The mouse pen has automatic switching function. The internal program is used to determine whether the mouse pen operates in the mouse or the remote controller mode. That is, when the mouse pen 1a is pressed close to the disk for use, it operates in the mouse mode. Contrarily, when the mouse pen is taken away a certain distance from the disk for use, it operates in the remote controller mode.

(3). The mouse pen has manual switching function. The mouse pen can be directly designated to operate in the mouse or the remote controller mode by using switches, hence letting the user have flexible selection of operation.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

I claim:

1. A mouse pen device having remote-control function comprising:
an optical detection unit for emitting light and receiving a reflected light signal;
a control unit electrically connected to the optical detection unit, said control unit comparing the reflected light signal received by said optical detection unit with a preset value, whether said control unit operates in the mouse or remote controller mode being determined according to the comparison result;
an operation unit electrically connected to said control unit; and
a wireless emission unit electrically connected to said control unit, said wireless emission unit being used to emit a signal processed by said control unit.

2. The mouse pen device having remote-control function as claimed in claim 1, wherein said control unit operates in the mouse mode when the reflected light signal is larger than the preset value.

3. The mouse pen device having remote-control function as claimed in claim 1, wherein said control unit operates in the remote controller mode when the reflected light signal is smaller than the preset value.

4. The mouse pen device having remote-control function as claimed in claim 1, wherein said control unit can further be switched to operate in the mouse or the remote controller mode by manually switching switches.

5. The mouse pen device having remote-control function as claimed in claim 1, wherein said operation unit comprises several keys, and said keys are defined as mouse keys or remote controller keys according to whether said control unit operates in the mouse or the remote controller mode.

6. The mouse pen device having remote-control function as claimed in claim 5, wherein when said keys are defined as the mouse keys, they are a mouse left key, a mouse wheel key, and a mouse right key, respectively.

7. The mouse pen device having remote-control function as claimed in claim 5, wherein when said keys are defined as the remote controller keys, they are a page up key, a scroll key, and a page down key, respectively.

8. The mouse pen device having remote-control function as claimed in claim 1, wherein a front end of said mouse pen is connected with a detection head for detecting the motion of said mouse pen through a rotation mechanism.
